(19) United States
(12) Patent Application Publication
(10) Pub. No.: US 2012/0223664 A1
(43) Pub. Date: Sep. 6, 2012

(54) POWER SWITCH ARRANGEMENT FOR AN INVERTER

(75) Inventor: Robert Januschevski, Tettnang (DE)

(73) Assignee: ZF FRIEDRICHSHAFEN AG, Friedrichshafen (DE)

(21) Appl. No.: 13/508,426

(22) PCT Filed: Oct. 29, 2010
(86) PCT No.: PCT/EP10/66426

§ 371 Date: May 7, 2012

(30) Foreign Application Priority Data
Nov. 11, 2009 (DE) 10 2009 046 615.0

(51) Int. Cl. H02P 6/14

(52) U.S. Cl. 318/400.26

(57) ABSTRACT

A power switch arrangement (1) for an inverter, particularly a drive inverter, the power switch arrangement (1) having a power semiconductor switch (2) and a protective circuit (3) disposed at the power semiconductor switch (2) protecting against reverse voltage transfer from the three-phase motor (5) that can be connected to the power semiconductor switch. The semiconductor power switch (2) having a control input (2a) and a switch input (2b), and a switch output (2c). The protective circuit (3) includes a series circuit, having a zener diode (7) and a first ohmic resistance (8), connected between the switch input (2b) and the control input (2a), and a series circuit, having a second ohmic resistance (9) and a diode (10), switched between the control input (2a) and the switch output (2c).

This application is a National Stage completion of PCT/EP2010/066426 filed Oct. 29, 2010, which claims priority from German patent application serial no. 10 2009 046 615.0 filed Nov. 11, 2009.

### FIELD OF THE INVENTION

The present invention relates to a power switch arrangement for an inverter.

### BACKGROUND OF THE INVENTION

Converters and the like are used for controlling electric machines, wherein the machines are supplied, for example, by means of a direct current source; however, one or more alternating current phases are required for operation. Such machines are particularly those in the field of motor vehicle drive engineering, such as three-phase motors, for instance permanently excited or externally excited synchronous motors.

A converter comprises a motor-side inverter, or respectively a drive inverter, for converting direct voltage from, for example, an intermediate circuit of the converter, particularly from an intermediate circuit with an intermediate circuit capacitor, into an alternating voltage at the desired frequency for controlling the direction of rotation and the rotational speed of the three-phase motor to be driven. Such drive inverters are used in particular in motor vehicles, for example in electrically driven motor vehicles, wherein the three-phase motor is designed as vehicle drive motor.

Such vehicle drive motors, particularly permanently excited synchronous motors, typically display the design-dependent behavior that during operation a counter-voltage, or respectively an internal voltage (synchronous generated voltage), is induced which increases with increasing rotational speed and which at very high rotational speeds is supplied, or fed back, into the intermediate circuit particularly by means of the free-wheeling diodes of the (drive) inverter and can lead to damage in the converter or the inverter, the battery, and further components. In the prior art, in order to be able to avoid this damage, while still being able to operate the motor at high speeds, field weakening is applied above the rated rotational speed in order to avoid a damaging reverse voltage transfer. Nevertheless, damage to the converter or further components is possible even with the use of field weakening, particularly if a motor is operated above the rated rotational speed (field weakening operation), and a field weakening current can no longer be maintained, for example. This can be caused by malfunctioning control electronics, for example.

In order to protect the converter from damaging reverse voltage transfer in the case of an unintentional voltage increase on the side of the alternating voltage (thus, originating from the motor), the prior art proposes different protective circuits. Typically, in the case of failure, power semiconductor circuits of the converter, or its motor side inverter, and thus the respective motor terminals connected therewith, are short-circuited. Short-circuiting via the bridge circuit can prevent damage to the intermediate circuit capacitor, a battery, the power switch, etc., for example, and with it the converter, caused by the induced voltage as a consequence of the rotation of the rotor. The known arrangements have a weakness however, in that the short circuit must be performed actively by control electronics of the inverter. In the event that the control electronics fail, no protection mechanism is provided against damage which occurs due to the voltage induced in the synchronous machine, or in the motor.

The document DE 102 51 977 A1 discloses a synchronous motor of the present type with an active control mechanism for short circuiting the power semiconductor switch of the power electronics. This protection mechanism is disadvantageous insofar as a large number of components are used, particularly active components, thereby significantly increasing the costs and complexity of the arrangement. The document DE 10 2005 009 341 A1 discloses a protection arrangement for a power output stage which has a logic and measuring unit. This arrangement is also complicated and costly to implement with the use of expensive active components. The document DE 298 13 080 U1 shows a further protection mechanism against reverse transfer voltage of an electrical drive, wherein the protection mechanism in turn requires complex electronics and an energy supply by means of the electrical drive. The document DE 198 35 576 A1 discloses a control system for a permanently excited electric motor which contains a unit to detect operating conditions in order to produce a short circuit if required. This arrangement, as with the prior arrangements, is also complicated, costly and cannot be implemented without the use of active components.

### SUMMARY OF THE INVENTION

Proceeding from this background, the object addressed by the present invention is to solve the problems described above, and to create a power switch arrangement for an inverter which provides an appropriate protection against reverse voltage transfer of a three-phase motor in a simple manner and that does not require any additional active components.

The invention proposes a power switch arrangement for an inverter, particularly a drive inverter, where the power switch arrangement comprises a power semiconductor switch and, disposed at the power semiconductor switch, a protective circuit against reverse voltage transfer of the three-phase motor that can be connected to the power semiconductor switch, the semiconductor power switch comprising a control input and an input, and an output, where the protective circuit comprises a series circuit, having a zener diode and a first ohmic resistance, connected between the input and the control input, and a series circuit, having a second ohmic resistance and a diode, switched between the control input and the output. The zener diode is disposed in the reverse direction between the input and the control input of the power semiconductor circuit. The diode is disposed particularly in the forward direction between the control input and the output of the power semiconductor switch.

In one embodiment of the power switch arrangement according to the invention, the protective circuit comprises exactly one zener diode and/or exactly one diode. Further it is provided that the protective circuit comprises exactly a first and/or exactly a second ohmic resistance.

In a further embodiment of the power switch arrangement according to the invention, the power semiconductor switch is a bipolar transistor with an insulated gate electrode (IGBT), wherein the input is in the form of a collector electrode, the control input is in the form of a gate electrode, and the output is in the form of an emitter electrode.

In yet a further embodiment of the power switch arrangement according to the invention, the power semiconductor switch is a field-effect transistor (FET), particularly a metal-oxide-semiconductor field-effect transistor (MOSFET), wherein the input is in the form of a drain electrode, the control input is in the form of a gate electrode, and the output is in the form of a source electrode.

Furthermore, an inverter is proposed for supplying a three-phase motor with electrical energy, particularly a motor vehicle drive motor, where the inverter comprises a half bridge for connecting to a winding strand of the three-phase motor, where the half bridge comprises a power switch arrangement according to the invention.

According to one embodiment of the invention, the inverter comprises one power switch arrangement per half bridge.

Further, in one embodiment of the inverter, the half bridge comprises an electrical connection for a winding of a three-phase motor, which is electrically connected to the input of a power semiconductor switch of the power switch arrangement.

According to a further embodiment of an inverter, a half bridge comprises two power switch arrangements.

Further, a drive arrangement is proposed for a motor vehicle with a three-phase motor, which is supplied with electrical energy by means of an inverter, wherein the inverter comprises a bridge circuit for the energy supply of the three-phase motor, where the bridge circuit comprises a power switch arrangement according to the invention.

In an embodiment of the drive arrangement according to the invention, the three-phase motor is a synchronous motor, particularly a vehicle motor. Here, the three-phase motor can be a permanently excited motor or an externally excited motor.

According to yet a further embodiment of the drive arrangement, the bridge circuit comprises a half bridge with a power switch arrangement.

Further features and advantages of the invention arise from the following description of example embodiments of the invention based on the figures of the drawings which show individual units essential to the invention, and from the claims. The individual features can be implemented alone or combined in any combination in a variant of the invention.

### BRIEF DESCRIPTION OF THE DRAWINGS

Preferred embodiments of the invention are explained in the following in more detail using the attached figures. The drawings show:

FIG. 1 an example of a bridge circuit of the motor-side inverter of a converter using power switch arrangements according to one possible embodiment of the invention; and

FIG. 2 an example of a power switch arrangement according to a possible embodiment of the invention.

### DETAILED DESCRIPTION OF THE PREFERRED EMBODIMENTS

Elements that are the same or have the same function in the following description and the figures have the same reference numbers.

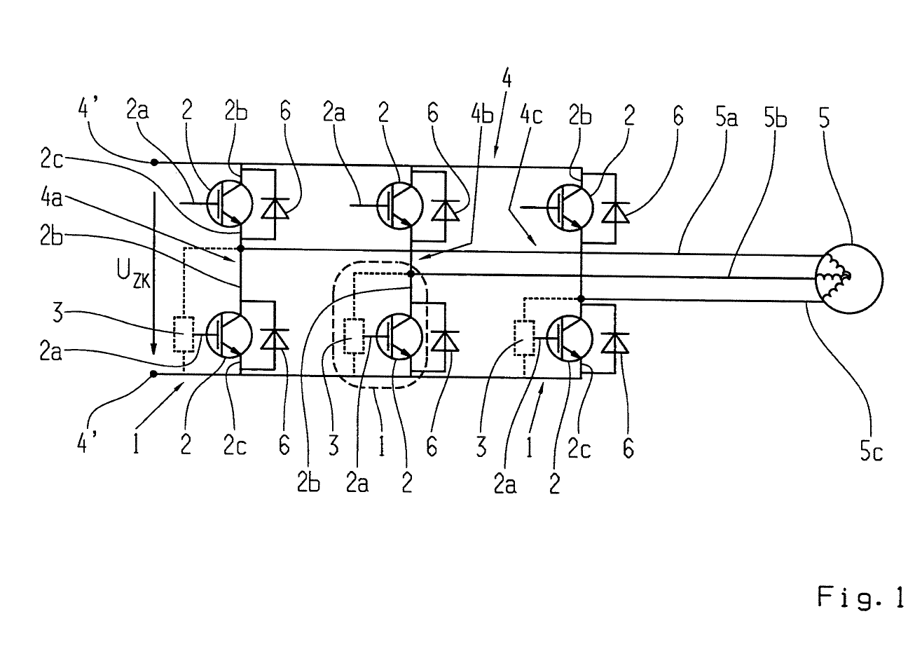

FIG. 1 shows a power switch arrangement 1 according to the invention, particularly for protecting against reverse voltage transfer of a three-phase motor, having a power semiconductor switch 2 and a protective circuit 3 according to the invention in a bridge circuit 4, for example, of a motor-side inverter, or drive inverter, particularly an inverter for a permanently excited or externally excited synchronous motor, which is used for instance as a motor vehicle drive motor 5. Here, the inverter is part of a converter for example.

A converter comprises in a known manner, for example, a rectifier (not shown) that supplies an intermediate circuit, in which an intermediate circuit capacitor is disposed, for example. The intermediate circuit supplies an intermediate circuit voltage U_{ZK} for example, particularly as a direct voltage, at the input 4′ of the inverter for example, for the bridge circuit 4 of the drive inverter, for generating the alternating voltage provided for operating the motor. The inverter generates an alternating voltage for example, as an output voltage with variable voltage and frequency, in order to control the direction of rotation and rotational speed of a three-phase motor 5 connected thereto, for example.

The intermediate circuit voltage U_{ZK} is present at the input terminal 4′, for example, of the bridge circuit 4, each of which has a half bridge 4a, 4b, 4c, each of which is electrically connected, for example via a center tap, in a known manner to a winding strand 5a, 5b, 5c of the three-phase motor 5. Here, the three-phase motor 5 is designed as a three-phase motor, for example, whose winding strands 5a, 5b, 5c are each supplied by a half bridge 4a, 4b, 4c. A voltage, or a potential, of predetermined polarity is delivered for a defined duration to each strand 5a, 5b, 5c of the three-phase motor 5 by the respective half bridge 4a, 4b, 4c. For this purpose, the power semiconductor switches 2 of the half bridges 4a, 4b, 4c are each correspondingly controlled in a known manner by means of control logic, for example.

A half bridge 4a, 4b, 4c comprises, for example, two power semiconductor switches 2, which are in the form, for example, of a bipolar transistor with an insulated gate electrode (insulated gate bipolar transistor, IGBT) or as a field-effect transistor (FET), in the form, for example, of a metal-oxide-semiconductor field-effect transistor (MOSFET). The power semiconductor switches 2 are designed and appropriately dimensioned, particularly for the voltages occurring in the converter or in the drive inverter, for example. However, further power semiconductor switches are also conceivable.

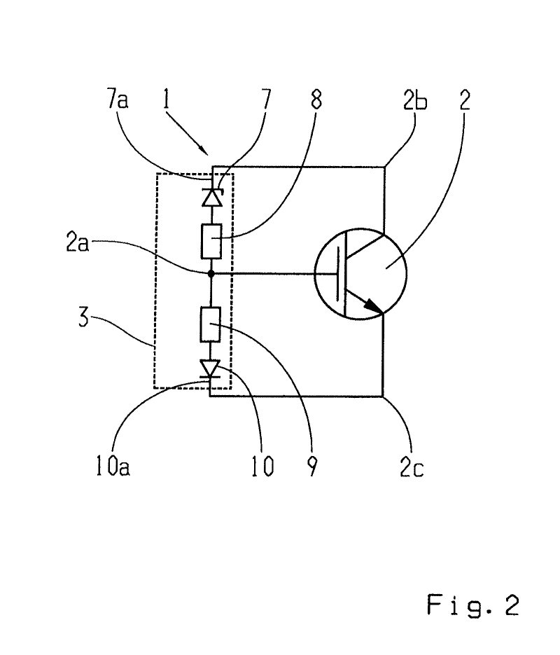

The power semiconductor switches 2 (FIG. 2) each comprise a control input 2a, for example in the form of a gate electrode, and an input 2b, for example in the form of a collector electrode (IGBT) or a drain electrode (MOSFET) and an output 2c, for example in the form of an emitter electrode (IGBT) or source electrode (MOSFET). A free-wheeling diode 6, for example, is connected in parallel between the input 2b and the output 2c, in a known manner.

The power semiconductor switches 2 are controlled via the respective control input 2a thereof, or control connection, in a known manner, for example by control electronics (not shown), where as a result of the control, a short circuit can be produced between the input 2b and the output 2c, in other words, the power semiconductor 2 is switched on.

According to the invention a power semiconductor switch 2, for example of the bridge circuit 4, comprises a protective circuit 3 according to the invention disposed thereon or assigned thereto, for forming a power switch arrangement 1 according to the invention, which protects the inverter and/or the converter from damage in the event of a voltage surge or a reverse voltage transfer for example, fed back from the three-phase motor 5, particularly in connection with one or more further power switch arrangements 1 of the bridge circuit 4.

For forming the power switch arrangement 1 according to the invention, the power semiconductor switch 2 is connected to the protective circuit 3, or the protective circuit 3 is disposed thereon. The protective circuit 3 is comprised substantially of a zener diode 7, a first 8 and a second 9 ohmic resistance and a diode 10 connected in series. A first end of this series circuit, i.e., an electrical connection 7a of the zener diode 7, for example, is provided here for the electrically conductive connection to the input 2b of the power semiconductor switch 2, a second end of the series circuit, i.e., an electrical connection 10a of the second diode 10, for example, is provided here for the electrically conductive connection to the output 2c of the power semiconductor switch 2. The connection to the control input 2a of the power semiconductor switch 2 is provided, for example by means of an electrical connection, or a terminal, between the first 8 and the second 9 ohmic resistance, which form a voltage divider. Instead of the first 8 and/or second 9 ohmic resistance, it is conceivable to use a parallel circuit of ohmic resistances, or a series circuit of ohmic resistances for example.

For the arrangement of the protective circuit 3 at a power semiconductor switch 2, or for the connection of such a circuit for forming a power switch arrangement 1 according to the invention, the zener diode 7, which upon reaching, or after reaching, the breakdown voltage thereof is conducting, is connected to the first ohmic resistance 8 in series between the input 2b and the control input 2a, and namely in the first sequence (FIG. 2) described above. Starting from the input 2b (of the power semiconductor switch 2 connected to the protective circuit 3), the zener diode 7 is first electrically connected to the input 2b and then the first ohmic resistance 8 is disposed in series with the control input 2a, thus between the zener diode 7 and the control input 2a, and electrically connected thereto. Here, the zener diode 7 is disposed particularly in the reverse direction. The reverse direction means that no current flow (technical current direction) is possible, or provided, in the direction from the input 2b to the control input 2a until the breakdown voltage of the zenor diode 7 is reached.

Furthermore, according to the invention, the series circuit of the second ohmic resistance 9 and the diode 10 is connected between the control input 2a of the power semiconductor switch 2 and the output 2c thereof, specifically in the second sequence (FIG. 2) described above. Starting from the control output 2a (of the power semiconductor switch 2 connected to the protective circuit 3), the second ohmic resistance 9 is first electrically connected thereto, and then the diode 10 is disposed in series there, thus between the second ohmic resistance 9 and the output 2c, and electrically connected thereto. Here, the diode 10 is disposed particularly in the forward direction. The forward direction with respect to the diode means that a current flow (technical current direction) is possible, or is provided, in the direction from the control input 2a to the output 2c, however not in the opposite direction.

Further, the known arrangement of the free-wheeling diode 6 is provided at the thusly formed power switch arrangement 1, in parallel to the input 2b and the output 2c of the power semiconductor switch 2 of the power switch arrangement 1.

For implementing an inverter according to the invention protected against damaging reverse voltage transfer, as shown in FIG. 1, a power switch arrangement 1 according to the invention can be disposed for each half bridge 4a, 4b, 4c of the (drive) inverter, in order to be able to short circuit all winding strands of the motor 5, for example three winding strands 5a, 5b 5c with the represented motor 5 operated as three-phase, particularly in the case of a malfunction. Here, a power switch arrangement 1 according to the invention is electrically connected, for example to a winding strand 5a, or 5b, or 5c of the motor 5 in each case via input 2b of the associated power semiconductor switch 2, and similarly, for example, to the output 2c of the further power semiconductor switch 2 of the respective half bridge 4a, or 4b, or 4c. The output 2c of the respective power semiconductor switch 2 of the power switch arrangement 1 is connected in the conventional manner, for example to a terminal, or a potential of the intermediate circuit; the control input 2a is connected in a known manner, for example to the control electronics. Further arrangements of the power switch arrangements 1 in an inverter are also conceivable, for example as a substitute for all power semiconductor switches 2. The protective circuits 3 can also be disposed subsequently at one or more power semiconductor switches 2 already present in the inverter, for forming power switch arrangements 1 according to the invention, for example as an add-on solution. It is conceivable to replace only one row of the bridge circuit 4, for example (see FIG. 1) the lower, or only the upper row of power semiconductor switches 2, by power switch arrangements 1, or to dispose protective circuits 3 at the power semiconductor switches 2. The protective circuit 3 can be integrated (IC), for example, directly into a power semiconductor switch 2, for instance an IGBT, or MOSFET, which are designed as an integrated circuit or as a component.

In the case of a potentially damaging reverse voltage transfer, as soon as the voltage induced by the drive motor, for example the synchronous motor, surpasses the reverse voltage of the zener diode 7, a current flows according to the invention through all elements of the protective circuit 3 of the power switch arrangement 1, i.e. through the zener diode 7, first 8 and second 9 resistance and diode 10. The first 8 and the second 9 ohmic resistances form a voltage divider circuit, or voltage divider, which ensures control of the power semiconductor switch 2 via the control input 2a thereof. The power semiconductor switch 2 is short circuited, and with it the voltage decreases below the reverse voltage of the zener diode 7. Thus, a maximum voltage is set at the power semiconductor switch 2 that is always less than the reverse voltage of the zener diode 7. The zener diode 7 limits the voltage that is fed back from the three-phase motor 5 to a defined value, i.e., depending on the breakdown voltage thereof. Thus, active components are not required for producing the passive voltage regulation implemented according to the invention; an active control, for example, by means of control electronics and an additional supply voltage are not required. The power switch arrangement 1 according to the invention creates additionally protection against brief voltage surge pulses originating from the direct current side of the converter (e.g., from the rectifier unit and/or the intermediate circuit) particularly originating from block capacitors or varistors.

### REFERENCE CHARACTERS

1 power switch arrangement
2 power semiconductor switch
2a control input
2b input
2c output
3 protective circuit
4 bridge circuit
4′ input terminals
4a, 4b, 4c half bridge
5 three-phase motor
5a, 5b, 5c winding strand
6 free-wheeling diode
7 zener diode
7a electrical connection zener diode (first end of the protective circuit)
8 first ohmic resistance
9 second ohmic resistance
10 diode
10a electrical connection diode (second end of the protective circuit)

1-15. (canceled)

16. A power switch arrangement (1) for an inverter, the power switch arrangement (1) comprising:
a power semiconductor switch (2),
a protective circuit (3) disposed at the power semiconductor switch (2) protecting against reverse voltage transfer from a three-phase motor (5) that is connectable to the power semiconductor switch,
the semiconductor power switch (2) having a control input (2a), a switch input (2b) and a switch output (2c),
the protective circuit (3) comprising a series circuit having a zener diode (7) and a first ohmic resistance (8), connected between the switch input (2b) and the control input (2a), and
the series circuit having a second ohmic resistance (9) and a further diode (10) switched between the control input (2a) and the switch output (2c).

17. The power switch arrangement (1) according to claim 16, wherein the zener diode (7) is disposed in a reverse direction between the switch input (2b) and the control input (2a) of the power semiconductor switch (2).

18. The power switch arrangement (1) according to claim 16, wherein the further diode (10) is disposed in a forward direction between the control input (2a) and the switch output (2c) of the power semiconductor switch (2).

19. The power switch arrangement (1) according to claim 16, wherein the protective circuit (3) comprises at least one of exactly one zener diode (7) and exactly one further diode (10).

20. The power switch arrangement (1) according to claim 16, wherein the protective circuit (3) comprises at least one of exactly one first ohmic resistance (8) and exactly one second ohmic resistance (9).

21. The power switch arrangement (1) according to claim 16, wherein the power semiconductor switch (2) is a bipolar transistor with an insulated gate electrode (IGBT),
the switch input (2b) is a collector electrode,
the control input (2a) is a gate electrode, and
the switch output (2c) is an emitter electrode.

22. The power switch arrangement (1) according to claim 16, wherein the power semiconductor switch (2) is a field-effect transistor (FET),
the switch input (2b) is a drain electrode,
the control input (2a) is a gate electrode, and
the switch output (2c) is a source electrode.

23. A power switch arrangement (1) in combination with an inverter for supplying a three-phase motor (5) with electrical energy, the inverter comprising:
a half bridge (4a, 4b, 4c) for connecting to a winding strand (5a, 5b, 5c) of the three-phase motor (5),
the half bridge (4a, 4b, 4c) comprising the power switch arrangement (1) comprising a power semiconductor switch (2) and a protective circuit (3) disposed at the power semiconductor switch (2) for protecting against reverse voltage transfer from the three-phase motor (5) that is connectable to the power semiconductor switch,
the semiconductor power switch (2) having a control input (2a), a switch input (2b) and a switch output (2c),
the protective circuit (3) comprises a series circuit having a zener diode (7) and a first ohmic resistance (8), connected between the switch input (2b) and the control input (2a), and
the series circuit having a second ohmic resistance (9) and a further diode (10) switched between the control input (2a) and the switch output (2c)

24. The inverter according to claim 23, wherein the inverter comprises a power switch arrangement (1) for each half bridge (4a, 4b, 4c).

25. The inverter according to claim 23, wherein the half bridge (4a, 4b, 4c) comprises an electrical connection for the winding strand (5a, 5b, 5c) of the three-phase motor (5), which is electrically connected to the switch input (2b) of the power semiconductor circuit (2) of the power switch arrangement (1).

26. The inverter according to claim 23, wherein the half bridge (4a, 4b, 4c) comprises two power switch arrangements (1).

27. A power switch arrangement (1) for an inverter in combination with a drive arrangement for a motor vehicle, containing a three-phase motor (5) which is supplied with electrical energy by the inverter, the inverter comprising:
a bridge circuit (4) for the energy supply of the three-phase motor (5),
the bridge circuit (4) comprising the power switch arrangement (1) which comprises a power semiconductor switch (2) and a protective circuit (3) disposed at the power semiconductor switch (2) for protecting against reverse voltage transfer from the three-phase motor (5) that is connectable to the power semiconductor switch,
the semiconductor power switch (2) having a control input (2a), a switch input (2b) and a switch output (2c),
the protective circuit (3) comprising a series circuit having a zener diode (7) and a first ohmic resistance (8), connected between the switch input (2b) and the control input (2a), and
the series circuit having a second ohmic resistance (9) and a further diode (10) switched between the control input (2a) and the switch output (2c)

28. The drive arrangement according to claim 27, wherein the three-phase motor (5) is a synchronous motor.

29. The drive arrangement according to claim 27, wherein the three-phase motor (5) is either a permanently excited motor or an externally excited motor.

30. The drive arrangement according to claim 27, wherein the bridge circuit (4) comprises a half bridge (4a, 4b, 4c) with the power switch arrangement (1).
